(19) United States
(12) Patent Application Publication
(10) Pub. No.: US 2018/0084327 A1
(43) Pub. Date: Mar. 22, 2018

(54) SET OF HEADPHONES AND HEADPHONE CABLE

(71) Applicant: MIDBASS DISTRIBUTION LIMITED, SUTTON COLDFIELD, OT (GB)

(72) Inventor: CARL VENABLES, SUTTON COLDFIELD (GB)

(21) Appl. No.: 15/561,781

(22) PCT Filed: Jan. 3, 2017
(86) PCT No.: PCT/GB2017/050003

§ 371 Date: Sep. 26, 2017

(30) Foreign Application Priority Data
Jan. 4, 2016 (GB) 1600086.1

(51) Int. Cl. H04R 1/10

(52) U.S. Cl. CPC H04R 1/1033; H04R 1/1091; H04R 1/1016

(57) ABSTRACT

This invention relates to a set of headphones (10), and in particular to a set of headphones comprising a pair of earpieces (14) as may be used with a personal media device such as an MP3 player, MP4 player, mobile telephone, smart phone, e-book reader, tablet computer, or the like. The set of headphones (10) has a jack plug (12) connected to the earpieces by a flexible cable (16), the flexible cable comprising a main cable (20; 120; 220) carrying two signal wires and two branch cables (22a, b) each carrying one signal wire. A keeper (40) is movably mounted upon the branch cables and holds the branch cables together. A receiver (56; 256) is provided for receiving a part of the jack plug, the receiver being separate from the keeper.

### FIELD OF THE INVENTION

This invention relates to a set of headphones, and in particular to a set of headphones comprising a pair of in-ear-headphones (often called earphones), as may be used with a personal media device such as an MP3 player, MP4 player, mobile telephone, smart phone, e-book reader, tablet computer, or the like. The invention also relates to the cable for the headphones, the cable having a jack plug by which the headphones are connected to the personal media device.

The invention does not exclude a set of headphones having a single earpiece, although the invention is likely to find its greatest utility in relation to sets of headphones having a pair of earpieces.

### BACKGROUND TO THE INVENTION

Many personal media devices such as MP3 players require the use of headphones in order for the user to listen to music. Thus, these devices often do not have any built-in (internal) speakers and so are designed for use with headphones. The headphones are typically connected to the personal media device by way of a jack plug and a length of flexible cable.

Furthermore, many devices such as mobile telephones, tablet computers, laptop computers and desktop computers have internal speakers, but nevertheless benefit greatly from the use of headphones. Such devices are often used to play music, and can also be used to display films, television programmes and games. The internal speakers which are fitted to such devices are often of low quality and whilst they may be suitable for voice communication they usually do not reproduce music or other media with an acceptable sound quality. Also, the user may wish to listen to music without disturbing others, so that the use of headphones is necessary. Accordingly, the manufacturers of mobile telephones and the like will typically provide an audio socket to receive the jack plug of a set of headphones, even if the device has an internal speaker.

The present invention can be utilised with any personal media device having an audio socket for headphones, whether or not the device has an internal speaker. For example, the present invention can be used with MP3 players, MP4 players, mobile telephones, tablet computers, laptop computers, desktop computers, CD players, DVD players, Bluray players, TV sets, AM/FM/DAB radios, guitar amplifiers and video games consoles (for example).

As indicated above, the headphones are connected to the personal media device by a length of flexible cable, the flexible cable terminating in a jack plug (of standard form) which can be inserted into the audio socket (also of standard form) of the device. The cable will often be around one metre long, permitting the user to use the headphones whilst carrying the device in a waist pocket or the like.

Headphones fall into two broad classes which are distinguished by the size and shape of their earpieces. The first class has two cup-shaped earpieces, each of which is designed to be placed against the user's head and surround a respective ear. The earpieces are typically mounted upon a support which fits over the user's head. The second class has much smaller earpieces, each of which is designed to fit snugly into a user's ear. Headphones in the second class are often referred to as in-ear headphones, earphones or earbuds. The present invention has been designed for use with in-ear headphones, and the following description will therefore relate to this class.

The known in-ear headphones have a number of known disadvantages. Firstly, when not in use the flexible cable will often become entangled during storage, requiring the user to untangle the cable before the headphones can be used. The likelihood of entanglement could be reduced by reducing the flexibility of the cable but that option is seldom adopted as a more flexible cable makes the headphones far easier to manipulate and use once the cable has been untangled.

Secondly, the electrical signal wire within the cable can become damaged during storage and/or during the untangling procedure, with the signal wire of a tangled cable perhaps being bent around curves with very small radii of curvature. Over time, such damage can become irrevocable, i.e. the signal wire can break.

The problems discussed above are exacerbated for in-ear headphones because each earpiece requires its own signal wire. Thus, unlike the first class of headphones which typically have a single cable carrying both signal wires connecting the earpieces to the jack plug, with the second class the signal wires are separated for at least part of their length.

Notwithstanding the requirement for two separate signal wires, the manufacturers of in-ear headphones have appreciated that the signal wires can be connected together for much of their length, whereby to reduce slightly the likelihood of the separate signal wires becoming entangled during storage. The in-ear headphones' cable therefore typically has a general Y-shape, with two separate branch cables each carrying a single signal wire meeting at a splitter (the junction of the “Y”), and a single main cable running from the splitter to the jack plug which carries both signal wires.

The two branch cables are typically of smaller cross-section than the main cable, and are usually very flexible. Their small cross-sectional dimension, and their significant flexibility, results in the branch cables being the most likely to become entangled and damaged. Accordingly, it is desirable to minimise the length of the branch cables. However, the branch cables must be sufficiently long to permit all users easily and conveniently to position each of the earpieces in a respective ear, with the attached branch cables being sufficiently long for the headphones to be comfortable to use. There is therefore a compromise between reducing the length of the separate branch cables so as to reduce the likelihood of entanglement and damage, and increasing the length of the separate branch cables so as to increase the ease of use and comfort of the user.

As an example, a known set of in-ear headphones has a cable with a total length of around 100 cm, and branch cables with a length of around 30 cm. Such a cable therefore has a total branch cable length of around 60 cm, the branch cables being very thin and very flexible, and being easily tangled during storage. It can be very difficult and time consuming subsequently to untangle the branch cables. The main cable of this known set of in-ear headphones has a length of around 70 cm and is also thin and flexible, the main cable contributing significantly to the overall likelihood of entanglement. It will be understood that the stated lengths are representative, and in-ear headphones having longer and shorter main and branch cable lengths are also known, as are in-ear headphones with a greater and lesser proportion of their total length taken up by the branch cables.

It is known to provide a movable keeper to hold the separate branch cables together, the keeper being a loop surrounding both of the branch cables. The user can slide the keeper towards the earpieces whereby to reduce the free length of the separate branch cables, and alternatively can slide the keeper away from the earpieces whereby to increase the free length. Such a keeper can slightly reduce the likelihood of entanglement during storage, but is usually only partially successful. Thus, to minimise the likelihood of entanglement it is necessary for the user to slide the keeper to a position adjacent to the earpieces before the cable is wound up for storage, and only the most diligent of users will routinely do this. Often, the keeper will be slid away from the earpieces during use, perhaps close to the splitter where the branch cables join with the main cable, and will not be moved before the in-ear headphones are stored, so that it will provide little or no benefit in reducing the likelihood of entanglement.

Prior art documents US 2005/0069147, WO 2012/064669 and US 2012/0045084 seek to reduce the disadvantage of the above-stated compromise by forming the branch cables with a series of interconnecting formations so that the two branch cables have the form of a zip fastener and can therefore be interconnected and disconnected by the user as desired.

There is another problem associated with headphone cables, namely that there is no easy way to store the cables during the periods when they are not in use. Many users will simply collect up the cable and store it in a pocket, for example. More diligent users may wind up the cable prior to storage. The collecting up and/or winding up of the cable increases the likelihood that the cable will become entangled, even if the earpiece cables have been interconnected by use of the zip-fastener arrangements described above.

WO 2010/132501 and WO 2014/147409 seek to avoid this latter problem by providing a receiver for the jack plug, the receiver allowing the temporary retention of the jack plug during storage. When the jack plug is located in the receiver a loop of cable is provided between the jack plug and the receiver, the loop enabling the headphones to be stored in the form of a necklace suitable for wearing around the neck of the user, or as a series of connected loops suitable for wearing as a bracelet around the wrist of the user.

Both of WO 2010/132501 and WO 2014/147409 disclose embodiments in which the receiver is located in a fixed position upon the cable (for example within one of the headphones or in the splitter between the main cable and the branch cables). Such an arrangement is relatively inflexible in that the length of the single loop formed in the cable is fixed. When stored in the form of a bracelet comprising several connected loops such a cable may be too loose or too tight depending upon the thickness of the user's wrist, the length of the formed loop, and the number of connected loops into which the cable is wound.

Both of WO 2010/132501 and WO 2014/147409 disclose other embodiments in which the receiver is movable. In WO 2010/132501 the receiver may be located in a movable slider which interconnects the branch cables. In WO 2014/147409 the receiver may be located in the fastener which moves along the branch cables and which also interconnects the branch cables.

A movable receiver allows some adjustment in the length of the formed loops so that when stored in the form of a bracelet for example the length of the connected loops can be adjusted for comfort. However, only a small amount of adjustment is possible since the receiver must be located close to the earpieces if the earpieces are to be retained rather than being free to move (and to become entangled) during the periods of storage.

### SUMMARY OF THE INVENTION

The inventor seeks to provide a set of headphones which share the benefits of the later prior art documents described above in allowing adjustment of the length of the formed loop of cable, but without affecting the retention of the earpieces. The inventor therefore seeks to provide a set of headphones which can readily be stored as a single loop or a series of connected loops so as to be wearable when not in use, with the earpieces being retained and with the length of the loop(s) being adjustable to suit the comfort of the user. In preferred embodiments the cable is designed to look attractive when worn in the stored condition (as a bracelet for example).

According to a first aspect of the invention there is provided a set of headphones having a jack plug and two earpieces, the jack plug being connected to the earpieces by a flexible cable, the flexible cable comprising a main cable carrying two signal wires and two branch cables each carrying one signal wire, a keeper movably mounted upon the branch cables and adapted to hold the branch cables together, and a receiver for receiving a part of the jack plug, the receiver being separate from the keeper.

The present invention therefore separates the function of the receiver from the keeper, allowing the keeper to perform the sole function of holding the branch cables together (and thereby retaining the earpieces) during storage. The receiver provides the separate function of retaining the jack plug during storage. As with the prior art documents the receiver is spaced from the jack plug so that when the jack plug is retained by the receiver the cable can be formed into one or more loops.

Preferably, the receiver can move relative to the cable so as to allow adjustment of the length of the formed loop(s). Such a receiver is movable along the cable independently of the movement of the keeper along the branch cables. Alternatively, the cable carries a plurality of receivers, each adapted to retain the jack plug. In this alternative arrangement the receivers do not necessarily move, but the plurality of receivers provides the necessary adjustment by allowing the user to select which of the receivers to use to retain the jack plug.

Preferably, the receiver is mounted upon the main cable. Such preferred embodiments therefore have a keeper upon the branch cables and a receiver upon the main cable. A single (movable) receiver can be provided upon the main cable, or a plurality of receivers as above indicated.

Desirably, the keeper has a first channel to receive a first branch cable and a second channel to receive a second branch cable. Ideally the first and second channels are substantially parallel. Preferably, the first and second channels are sized to be a friction fit around the branch cables so that a small force is required to move the keeper along the branch cables. It is desired in particular that the friction between the keeper and the branch cables is significantly greater than the weight of the keeper, so that the keeper does not move along the branch cables under its own weight, and the user is required to force the keeper to move along the branch cables. The keeper will therefore tend to remain in a position chosen by the user.

Preferably, the keeper is formed to cooperate with the earpieces so as to cause the earpieces to adopt a predetermined position relative to the keeper, and relative to each other, during storage. Thus, it is arranged that the keeper can be moved into engagement with the earpieces and when engaged the earpieces are forced to adopt their predetermined position. The earpieces in their predetermined position may be back-to-back, or side-by-side, or in another predetermined position allowing convenient storage, in particular when worn as a bracelet for example.

Desirably, the branch cables are acircular and the cable channels of the keeper are correspondingly acircular. Cooperating acircular shaping prevents the branch cables from twisting within the keeper, and therefore maintains a chosen orientation of the branch cables as they pass through the keeper. When the keeper is moved adjacent to the earpieces therefore, the orientation of the earpieces relative to each other, and relative to the keeper, is controlled. Preferably the cross-sectional shape of the branch cables is oval and the keeper channels are similarly shaped.

Desirably, each earpiece has a part which can locate into a respective channel of the keeper. Ideally, the part also acts as strain relief between the earpiece and its branch cable. The part can be acircular to match the acircular shape of the keeper channels. In addition, the part includes a projecting ring or rib which can locate into a recess or groove of a keeper channel to temporarily secure the earpiece relative to the keeper. The securing rib is preferably a continuous rib around the strain relief, the rib fitting into a correspondingly continuous annular recess in the channel of the keeper.

In the embodiments in which the receiver is movable it is preferably a friction fit upon the cable. Once again, this permits the user to select a suitable position for the receiver and ensures that the receiver will remain substantially in that position until again moved by the user.

In some embodiments the keeper also acts to interconnect the branch cables, perhaps in the fashion of a zip fastener or a zip-lock fastener as in certain of the prior art documents. However, this has been found to be unnecessary as the provision of a keeper which can hold the branch cables together adjacent to the earpieces, and a separate receiver, enable safe and reliable storage of the headphones when not in use, whilst at the same time reducing the likelihood of entanglement.

According to a second aspect of the invention there is provided a set of headphones having a jack plug and two earpieces, the jack plug being connected to the earpieces by a length of flexible cable, the length of flexible cable comprising a main cable carrying two signal wires and two branch cables each carrying one signal wire, a keeper movably mounted upon the branch cables and adapted to hold the branch cables together, the keeper having a first channel for one of the branch cables, a second channel for the other of the branch cables, and a further channel, the further channel being open-sided and adapted to receive the main cable.

Preferably, the keeper is flexible and resilient, the further channel being sized to be a friction fit upon the main cable.

Desirably, the further channel has a cable portion (the cable portion being sized to be a friction fit upon the main cable) and a neck portion, the neck portion being connected to the cable portion and being adapted to permit insertion and removal of the main cable to and from the cable portion, the minimum width of the neck portion being smaller than the cable portion. Accordingly, the neck portion provides a narrow slot through which the main cable must pass in order to enter and leave the cable portion. The keeper is sufficiently flexible to permit the neck portion to be stretched to allow the main cable to pass therethrough. The keeper is also sufficiently resilient that the (unstretched) neck portion retains the main cable within the cable portion.

Preferably, the neck portion lies directly between the first and second cable channels. The cable portion of the further channel therefore does not lie directly between the first and second channels and the cable portion and the first and second channels are arranged in a triangular array. Desirably, the neck portion converges towards the cable portion so that the narrowest part of the neck portion is immediately adjacent to the cable portion.

Features of the first aspect of the invention may be combined with features of the second aspect of the invention (and vice versa) with which they are compatible.

### BRIEF DESCRIPTION OF THE PREFERRED EMBODIMENTS

The invention will now be described in more detail, by way of example, with reference to the accompanying drawings, in which:

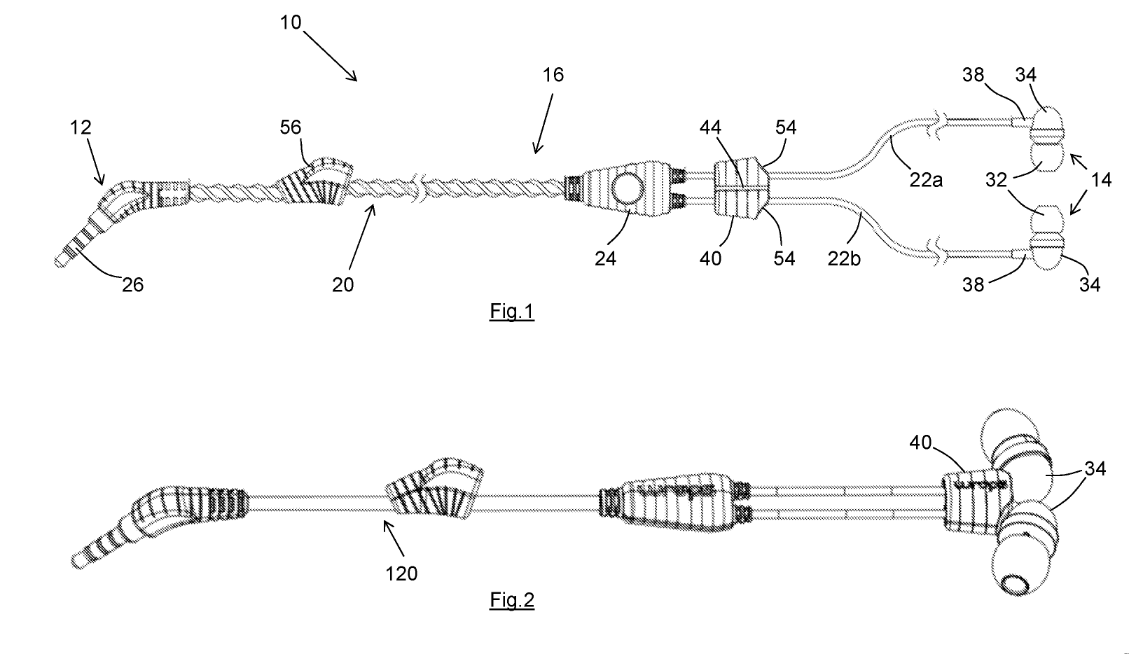

FIG. 1 shows a headphone cable according to a first embodiment of the present invention;

FIG. 2 shows a headphone cable according to a second embodiment of the present invention;

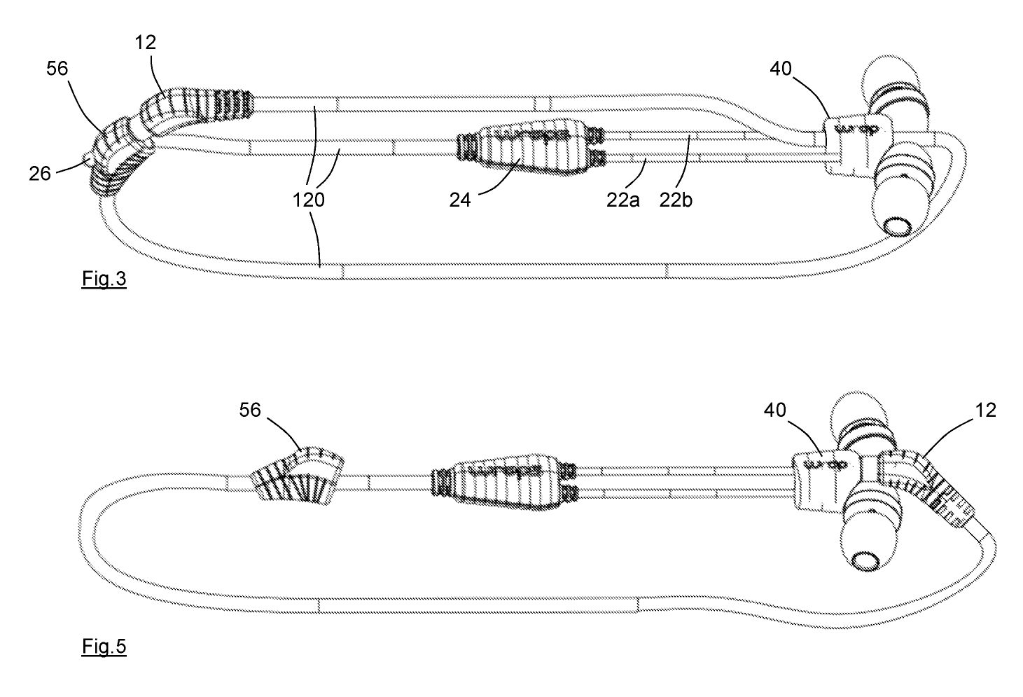

FIG. 3 shows the headphone cable of FIG. 2 is a first storage condition;

FIG. 4 shows the headphone cable of FIG. 2 in a second storage condition;

FIG. 5 shows the headphone cable of FIG. 2 in a third storage condition;

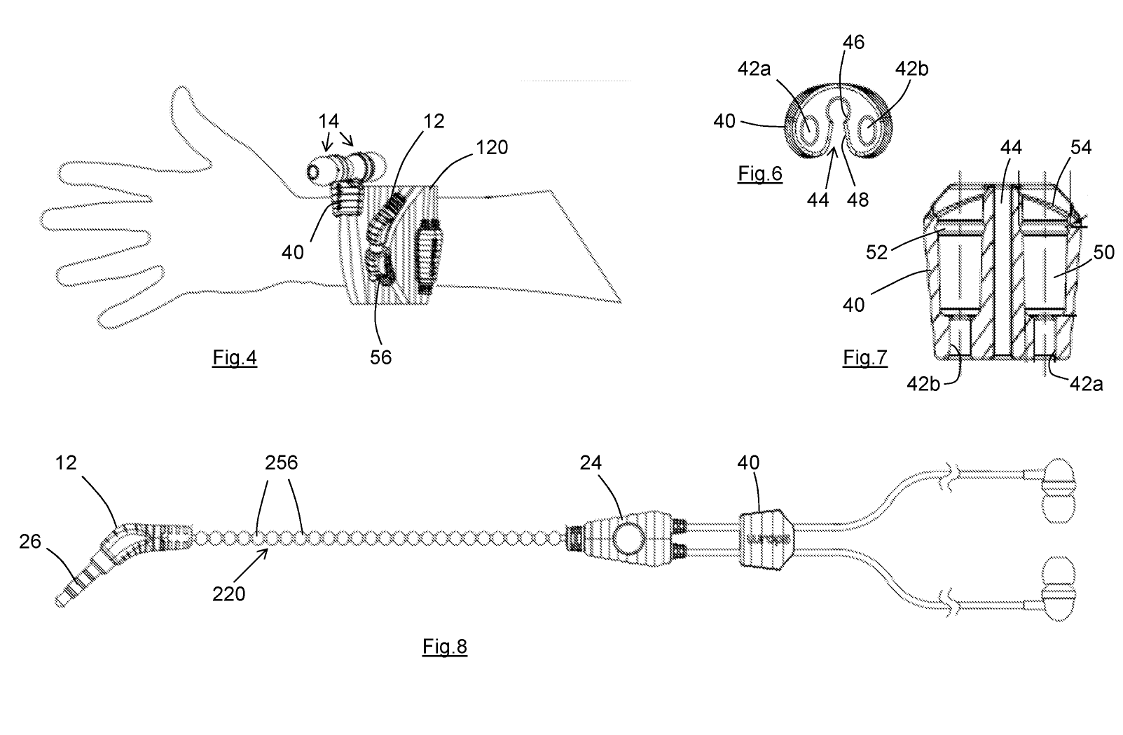

FIG. 6 shows the keeper of the first and second embodiments;

FIG. 7 shows a cross-sectional view through the keeper of FIG. 6; and

FIG. 8 shows a headphone cable according to a third embodiment of the present invention.

### DETAILED DESCRIPTION

The set of in-ear headphones 10 according to the present invention can be provided in a number of different embodiments and styles to match personal tastes. Only three of the many available embodiments are shown in the drawings.

In common with known sets of in-ear headphones, it is intended that all embodiments will be provided with a stereo jack plug 12, two earpieces 14, and a length of flexible cable 16 connecting the jack plug 12 to the earpieces 14.

The cable 16 carries two separate signal wires (not shown) and comprises a main cable 20 in which the two signal wires are located within a common casing, and two branch cables 22a, 22b each of which carries a single signal wire. The main cable 20 and the branch cables 22a, 22b are joined at a splitter 24.

It will be understood that the terminal or jack pin 26 of the stereo jack plug 12 is of standard form so that it can be inserted into the standard audio socket of a personal media device (not shown) such as an MP3 player for example. In preferred embodiments the separate sections of the jack pin 26 are gold plated.

The main cable 20 is preferably longer than the branch cables 22a,b, i.e. the splitter 24 is closer to the earpieces 14 than to the jack plug 12. In preferred embodiments the length of the main cable 20 is between around 50 and 80 cm, usefully between 60 and 75 cm, and ideally around 70 cm, whilst the length of the branch cables 22a and 22b is between around 25 cm and 50 cm, and ideally around 30 cm.

The earpieces 14 each have a flexible earbud 32, ideally of silicone, which locates within the user's ear in use. Preferably, the in-ear headphones 10 are supplied with a range of (perhaps three) differently-sized pairs of earbuds to permit the user to fit the pair of earbuds which most-closely match his or her ears. The earpieces 14 each also have a housing 34 containing a driver and a speaker in known fashion.

The branch cables 22a,b carry a keeper 40 (which may alternatively be referred to as a branch cable slide toggle) which can slide along the branch cables 22a,b between the splitter 24 and the earpieces 14. It will be understood that during use of the headphones 10 the keeper 40 will typically be located adjacent to the splitter (for example in or close to the position shown in FIG. 1) so that the free length of the branch cables 22a,b between the keeper 40 and the earpieces 14 (and therefore the ease and comfort of use) is maximised. When the headphones are not in use and it is desired to store the headphone cable 10 the keeper 40 should be slid along the branch cables 22a,b to a position adjacent to (and preferably in engagement with) the earpieces 14, as seen in FIG. 2.

It will be seen in these embodiments that the keeper 40 holds the branch cables 22a,b together (where the word “together” means that the branch cables are locally close to one another but not necessarily in contact). The keeper 40 does not act like a zip fastener to interconnect the branch cables as is the case in certain of the prior art documents, although the present invention does not exclude that additional functionality if required. Notwithstanding that the branch cables 22a,b between the splitter 24 and the keeper 40 can move apart, their tendency to become tangled during periods of non-use is much reduced so that interconnection is not expected to be necessary.

The first and second embodiments of FIGS. 1 and 2 differ only in the ornamentation of the main cable 20 of FIG. 1 which is absent from the main cable 120 of FIG. 2. The remaining components of these embodiments are drawn to be identical and therefore share the same reference numerals. Different embodiments can be provided which have one or more further different components, as desired.

As shown in FIG. 6, the keeper 40 has a first channel 42a and a second channel 42b, each of which is able to accommodate a respective branch cable 22a,b in the assembled condition of FIG. 1 etc. It is arranged that the cross-sectional dimensions of the channels 42a,b are chosen to provide a friction fit upon the branch cables 22a,b, so that the keeper 40 can be moved along the branch cables as desired by the user without excessive force, but with sufficient frictional resistance to maintain a chosen position along the branch cables when the keeper is released. Thus, when the keeper is moved to a chosen position along the branch cables 22a,b, such as the position shown in FIG. 1, it will tend to remain there until the user subsequently slides it to a different position.

The keeper 40 has a further channel 44 for the purposes to be described below. The further channel 44 is open-sided and comprises a cable portion 46 and a neck portion 48. The cable portion 46 is sized to be a friction fit upon the main cable 20, 120, and in this embodiment is also a friction fit upon the jack pin 26. The neck portion 48 tapers towards the cable portion 46, so that in this embodiment the narrowest part of the neck portion is immediately adjacent to the cable portion. Importantly, the narrowest part of the neck portion 48 is smaller than the cross-sectional dimension (width) of the cable portion, and therefore similarly smaller than the cross-sectional dimension (e.g. diameter if the main cable is circular) of the main cable 20, 120.

The keeper 40 is ideally made of plastics material and is sufficiently flexible to allow the neck portion 48 to be stretched so as to accommodate the main cable 20, 120 as it passes therethrough (the main cable 20, 120 may also be compressible to assist the passage through the neck portion 48). The keeper is, however, resilient so that the neck portion 48 retains a fitted main cable 20, 120 within the cable portion 46.

Accordingly, it will be understood that the main cable 20, 120 can be pressed (transversely) into the cable portion 46 by way of the neck portion 48, and can be retained thereby (as in FIG. 3). In addition, in this embodiment the jack pin 26 can be pressed (typically longitudinally but alternatively transversely if desired) into the cable portion 46 and can be retained thereby (as in FIG. 5).

It will be understood that the channels 42a,b could also be open-sided but since it is not intended to allow removal of the keeper 40 from the branch cables 22a,b, it is preferable that the first and second channels 42a,b are closed as shown.

It will be seen that the first and second channels 42a,b are acircular, in this embodiment oval in cross-section. The branch cables 22a,b are similarly oval. Despite their great flexibility, the branch cables 22a,b therefore cannot twist within the channels 42a,b and their orientation relative to the keeper 40 and relative to each other can be maintained adjacent to the keeper.

The controlled orientation of the branch cables 22a,b has significant benefits for storage of the headphones 10. It will be understood that when the headphones are to be stored the user should slide the keeper 40 into engagement with the earpieces 14, so that the likelihood of the branch cables 22a,b becoming entangled is minimised.

In this embodiment each earpiece 14 is securely connected to its respective branch cable 22a,b by way of a strain relief 38 (see FIG. 1). In known fashion, the strain relief 38 is a local thickening and strengthening of the casing at the end of a branch cable, and serves to reduce the deformation of the branch cable immediately adjacent to the earpiece 14 (that part of the branch cables otherwise being vulnerable to damage). In this embodiment the strain relief 38 is a plastic injection moulding made by a two-shot process which enables a secure connection to the (metal) earpiece housing 34.

Though not visible in FIG. 1, the strain relief 38 has an outwardly projecting annular rib or ring. As seen in FIG. 7, the keeper 40 is adapted to accommodate the strain relief 38 in the storage condition. The keeper channels each comprise a short length 42a,b shaped to cooperate with the (acircular) branch cables 22a, b and an enlarged region 50 sized to contain the strain relief 38. The projecting rib can locate into an annular groove or recess 52 in the enlarged region 50 of a respective channel 42a,b. In the stored condition of FIGS. 2-5 therefore, the keeper 40 has been moved along the branch cables 22a,b into engagement with the earpieces 14, with the strain relief 38 of each branch cable 22a,b, entering the respective enlarged region 50 of a channel of the keeper.

It will be observed that the outline of the keeper of FIG. 7 does not exactly match the outline of the keeper of FIG. 1, but the differences are minor and of no consequence to the present invention and so the same reference numeral is used for both embodiments.

The strain relief 38 may if desired by acircular to help maintain the orientation of the respective branch cable 22 and earpiece 14.

It will be understood that as the keeper 40 is moved towards the earpieces 14 any twists in the branch cables 22a,b are removed by the cooperating acircular form of the branch cables 22a,b and the keeper channels 42a,b, and as the strain relief 38 enters the respective channel 42a,b the orientation of the earpieces 14 to the keeper 40, and therefore to each other, is controlled.

Additionally, in this embodiment the keeper 40 has earpiece engagement surfaces 54 (FIG. 1) shaped to match that of the earpiece housings 34 so that when the keeper is moved into engagement with the earpieces 14, the earpieces are further caused to adopt (and remain in) a predetermined position relative to the keeper 40, and therefore relative to each other.

The strain relief 38 and the enlarged regions 50 can also be (correspondingly) acircular if desired, to further control the orientation of the earpieces 14 in the storage condition.

The relative position of the earpieces 14 in their stored condition is shown in FIGS. 2-5 and is therefore predetermined and controlled primarily by the cooperating acircular form of the branch cables 22a,b and the first and second channels 42a,b (and by the acircular form of the strain relief and enlarged regions 50 if provided), and secondly by the shaping of the earpiece engagement surfaces 54. That relative position has been chosen to maximise the neatness and convenience during storage (see in particular FIG. 4).

In addition, the cooperating rib of the strain relief 38 and recess 52 of the enlarged portions 50 retain the earpieces 14 in engagement with the keeper 40 during storage, thereby ensuring that the earpieces 14 maintain their predetermined positions. It will be understood that limiting the relative movement of the earpieces during storage will reduce the likelihood of damage to the earpieces and to their signal cables.

The main cable 16 also carries a receiver 56. Though not shown in the drawings, the receiver 56 has a socket or channel which can temporarily retain the jack plug 12 during storage. The receiver 56 is of plastic material and is sufficiently resilient that a socket or channel having a diameter slightly smaller than the jack pin 26 can retain the jack plug 12 by way of friction. In this embodiment the socket is an open-ended bore through the body of the receiver 56, the bore being shorter in length than the jack pin 26. The end of the jack pin 26 is therefore visible in FIG. 3 projecting beyond the socket. In other embodiments the socket is a blind bore.

In the first and second embodiments of FIGS. 1 and 2 the receiver 56 can slide along the main cable 20, 120, i.e. it has a channel (similar to one of the channels 42a,b) which can accommodate the main cable 20, 120 and which allows the receiver to slide along the main cable 20, 120 when the user overcomes the frictional resistance to movement. It can if desired be arranged that the frictional grip of the receiver 56 upon the main cable 20, 120 increases when the jack pin 26 is inserted into the socket, perhaps to the extent that the receiver is substantially locked in position by insertion of the jack plug.

FIG. 3 shows a first storage condition in which the cable 16 is wound into a single loop. Specifically, to store the headphones 10 in this condition the keeper 40 is moved into engagement with the earpieces 14 so that the earpieces adopt their predetermined positions. The main cable is then formed into a single loop and the jack pin 26 is pressed into the socket of the receiver 56.

In addition, a part of the main cable 120 is pressed into the open-sided channel 44 of the keeper 40, specifically being pressed through the neck portion 48 and into the cable portion 46. The part of the main cable 120 may be pressed into the open-sided channel before or after the jack pin 26 is inserted into the receiver 56, as desired.

It will also be understood that the connection of the main cable 120 to the keeper 40 as in FIG. 3 provides a single loop with the earpieces 14 retained thereby. Alternatively stated, the additional connection of the main cable 120 to the keeper 40 prevents the earpieces 14 and the branch cables 22a,b being free to move uncontrolledly during storage (which movement would increase the likelihood of entanglement and/or damage).

The single-loop storage condition of FIG. 3 allows the headphones 10 to the worn as a necklace or the like. It will be understood that the length of the loop can be adjusted by moving the receiver 56 along the main cable 120, with corresponding movement of the main cable through the channel 44 of the keeper 40.

FIG. 4 shows an alternative second storage condition in which the cable 16 is wound into a series of connected loops. To store the headphones 10 in this condition the keeper 40 is again firstly slid into engagement with the earpieces 14 as in FIG. 2. The main cable is then wound a chosen number of times (for example wound directly around the user's wrist) before the jack pin 26 is pressed into the socket of the receiver 56. The user will typically adjust the position of the receiver 56 before the jack pin 26 is inserted so as to achieve the desired storage condition. If the headphones are to be stored in this way primarily as a fashion accessory the loops will likely be relatively loose upon the user's wrist; if, however, the headphones are stored in this way whilst the user is active (for example jogging) the loops will likely be relatively tight upon the wrist.

It can be arranged that the receiver 56 can be moved by the user along the main cable with the jack pin 26 inserted into the socket, whereby to adjust the length of the loops for the user's comfort. Alternatively, it can be arranged that the jack pin 26 must be removed from the socket before the receiver 56 is moved.

In addition, as with the first storage condition of FIG. 3, part of the main cable 120 is pressed into the open-sided channel 44 of the keeper 40, typically before the jack pin 26 is inserted into the receiver 56, so as to help ensure that the earpieces 14 are retained.

In each of the first and second storage conditions, it will be understood that adjustment of the length of the loop(s) by moving the receiver along the main cable does not affect the position of the keeper 40. On the contrary, the keeper 40 is maintained in engagement with the earpieces 14 so that the free length of the branch cables is zero (or is at least minimised) during storage, regardless of the length of the loop (or loops) of the cable 16.

A third storage condition is shown in FIG. 5. In this storage condition the jack pin 26 is inserted into the cable portion 46 of the further channel 44 of the keeper 40. This storage condition is included for completeness, and is not preferred since it avoids the advantage of the user being able to adjust the length of the formed loop without moving the keeper 40 away from the earpieces 14. This third storage condition is therefore similar to certain of the prior art arrangements, in that whilst the keeper 40 can be moved along the branch cables to adjust the length of the loop of cable, such adjustment also alters the free length of the branch cables which is not necessary with the first and second storage conditions of FIGS. 3 and 4.

The third embodiment of FIG. 8 differs from the first and second embodiments in having multiple receivers. The main cable 220 carries a series of beads 256, some of which (or ideally all of which) are receivers having a channel or socket (not seen) to receive the jack pin 26. Whilst the beads 256 of FIG. 7 appear too small to receive the jack pin 26 they extend into the paper as drawn so that the sockets are not visible in FIG. 8. It will be understood that the beads 256 do not need to move along the main cable 220 in order to provide adjustment in the length of a formed loop since the user can achieve the required adjustment by selecting an appropriate receiver for the jack pin. In some embodiments, however, the beads do not completely fill the main cable 220 between the jack plug 12 and the splitter 24 so that the beads can move somewhat along the main cable. In such embodiments it can be arranged that the insertion of the jack pin 26 into a particular bead substantially locks that bead in position upon the main cable.

It will be seen that FIG. 1 shows breaks in the main cable 20 and branch cables 42a,b so that the full length of the respective cables is not shown; it will be understood that whilst similar breaks are not included in FIG. 2, 3 or 5 (nor in the main cable 220 of FIG. 8), those drawings do not represent the full length of the respective cables.

In embodiments suited for use with a mobile telephone, the keeper or the splitter can include a microphone and the keeper or splitter can additionally carry a switch to active the microphone. Alternatively the microphone can be located upon one of the branch cables between the splitter and the keeper.

1. A set of headphones (10) having a jack plug (12) and two earpieces (14), the jack plug being connected to the earpieces by a flexible cable (16), the flexible cable comprising a main cable (20; 120; 220) carrying two signal wires and two branch cables (22a,b) each carrying one signal wire, a keeper (40) movably mounted upon the branch cables and adapted to hold the branch cables together, and a receiver (56; 256) for receiving a part of the jack plug, the receiver being separate from the keeper.

2. The set of headphones according to claim 1 in which the receiver (56; 256) can move relative to the cable (16).

3. The set of headphones according to claim 1 in which the cable carries a plurality of receivers (256), each receiver being adapted to receive a part of the jack plug (12).

4. The set of headphones according to claim 1 in which the receiver (56; 256) is mounted upon the main cable (20; 120; 220).

5. The set of headphones according to claim 1 in which the keeper (40) has a first channel (42a) for a first branch cable (22a) and a second channel (42b) for a second branch cable (22b).

6. The set of headphones according to claim 5 in which the first and second channels (42a,b) are sized to be a friction fit upon the respective branch cable (22a,b).

7. The set of headphones according to claim 5 in which the branch cables (22a, b) are acircular and the first and second channels (42a,b) of the keeper 40 are correspondingly acircular.

8. The set of headphones according to claim 7 in which the cross-sectional shape of the branch cables (22a, b) is oval and the first and second channels (42a, b) are similarly shaped.

9. The set of headphones according to claim 5 in which each earpiece (14) has a part (38) which can be located in a respective channel (42a, b) of the keeper (40).

10. The set of headphones according to claim 9 in which the part (38) is acircular in cross-section.

11. The set of headphones according to claim 9 in which the part (38) includes a projecting rib which can locate into a recess (52) of a channel (42a,b) of the keeper (40).

12. The set of headphones according to claim 9 in which the projecting rib is a continuous ring around the part (38), and in which the recess is a continuous annular groove in the channel (42a,b) of the keeper (40).

13. The set of headphones according to claim 5 in which the keeper has a further channel (44), the further channel being open-sided and adapted to receive the main cable (20, 120).

14. The set of headphones according to claim 13 in which the further channel (44) has a cable portion (46) and a neck portion (48), the minimum width of the neck portion being smaller than the cable portion.

15. The set of headphones according to claim 14 in which the neck portion (48) tapers towards the cable portion (46).
